(19) United States
(12) Patent Application Publication
(10) Pub. No.: US 2023/0298028 A1
(43) Pub. Date: Sep. 21, 2023

(54) ANALYZING A TRANSACTION IN A PAYMENT PROCESSING SYSTEM

(71) Applicant: Fidelity Information Services, LLC, Jacksonville, FL (US)

(72) Inventors: Christiaan ERDBRINK, London (GB); Liam ELLIS, London (GB)

(73) Assignee: Fidelity Information Services, LLC, Jacksonville, FL (US)

(21) Appl. No.: 17/655,467

(22) Filed: Mar. 18, 2022

(51) Int. Cl. G06Q 20/40

(52) U.S. Cl. CPC G06Q 20/4016; G06Q 20/407

(57) ABSTRACT

A method for analyzing a transaction in a payment processing system includes receiving a transaction, classifying the transaction, analyzing the transaction, selecting a treatment to be applied to the transaction, applying the selected treatment to the transaction, and outputting the transaction after the selected treatment was applied to the transaction. Classifying the transaction includes computing a probability score vector for the transaction that indicates a probability for each of one or more possible outcomes of the transaction. Analyzing the transaction includes computing one or more probability mass vectors for the transaction that indicate impact values and associated probabilities of one or more possible treatments to be applied to the transaction. Selecting the treatment to be applied includes applying a set of decision rules to the probability score vector and the one or more probability mass vectors.

### BACKGROUND

The present disclosure generally relates to processing financial transactions and, more particularly, to a system and method for analyzing a transaction in a payment processing system to determine whether a treatment should be applied to the transaction.

FIG. 1 is a flow diagram of a payment processing system 100. The payment processing system 100 includes a buyer 102, a merchant 104, a payment processor 106, a card network 108, and an issuing bank 110. It is noted that the payment processing system 100 may include more or fewer entities than those shown in FIG. 1. For purposes of discussion, it is assumed that the entities in the payment processing system communicate electronically with each other through known means of electronic communication.

The buyer 102 shops at the merchant 104 with an electronic payment card (operation 120), and merchant 104 creates a transaction in response. The merchant 104 submits the transaction to the payment processor 106 (operation 122). The payment processor 106 submits the transaction to the card network 108 (operation 124). The card network 108 requests authorization for the transaction from the issuing bank 110 (operation 126). The issuing bank 110 is the entity that issued the electronic payment card to the buyer 102.

The issuing bank 110 determines whether to approve or deny the transaction and sends a response to the card network 108 (operation 128). The issuing bank 110 may consider any number of factors in determining whether to approve or deny the transaction, for example, whether the buyer has sufficient credit to be able to complete the transaction. The card network 108 sends the response to the payment processor 106 (operation 130) and the payment processor 106 sends the response to the merchant 104 (operation 132).

For a better shopping experience, it is desirable to complete the transaction approval process as quickly as possible. At some points in the process, for example at the payment processor 106, the card network 108, or the issuing bank 110, some actions may be automated and may include using artificial intelligence (AI) algorithms.

For example, a classification model may be implemented to determine whether the buyer 102 needs to be authenticated (for example, by password verification or by fingerprint verification if the buyer is using a mobile device). The classification model may be an automated risk assessment tool that, at the transaction level, decides whether to authenticate the buyer based on a suspicion of the transaction becoming fraud later on. The decision whether to authenticate the user or not may be referred to as a “soft intervention,” meaning that the decision is limited to whether the buyer should be authenticated, not whether to block the transaction if the risk of fraud is high.

To improve operation of the classification model, feedback may be provided. The feedback is used to train the classification model to help classify what is predicted to happen as a result of requesting the buyer authentication. This feedback is usually limited to whether the transaction ultimately turned out to be fraudulent or whether the transaction was authorized (and remains a genuine sale).

By limiting the feedback to whether the transaction was fraudulent or not (implying that the transaction was completed), it may not include all possible outcomes, for example if the transaction is not completed (and as such, it cannot be determined whether the transaction would have been fraudulent or not). If the classification model determines to request buyer authentication and the buyer cancels the transaction because they do not want to complete the authentication (known as “drop-off”), this feedback is usually not considered because the transaction was not completed. So requesting buyer authentication may, in certain circumstances, lead to lost sales. It may be beneficial to train the classification model to incorporate this additional feedback.

Large-scale transaction processing systems benefit from intelligent optimization measures to boost conversion rates. These measures or “treatments” may range from secure customer authentication checks to in-flight adjustments to the transaction's data fields. While the definitions of “favorable outcomes” may differ, a common element is often that data-driven machine learning models are applied to make automated decisions about whether incoming transactions should receive treatment or are better left untreated.

This decision-making may be sub-optimal when the wrong transactions receive treatment, or when the type of treatment is wrong. This leads to missed revenue and unnecessary costs for merchants due to canceled transactions or fraud that could have been prevented.

### SUMMARY

A method for analyzing a transaction in a payment processing system includes receiving a transaction, classifying the transaction, analyzing the transaction, selecting a treatment to be applied to the transaction, applying the selected treatment to the transaction, and outputting the transaction after the selected treatment was applied to the transaction. Classifying the transaction includes computing a probability score vector for the transaction that indicates a probability for each of one or more possible outcomes of the transaction. Analyzing the transaction includes computing one or more probability mass vectors for the transaction that indicate impact values and associated probabilities of one or more possible treatments to be applied to the transaction. Selecting the treatment to be applied includes applying a set of decision rules to the probability score vector and the one or more probability mass vectors. The transaction output is based on the selected treatment applied to the transaction, which then continues its way through the payment processing system before it reaches an outcome that is subsequently used to train the classification and analysis units.

A system for analyzing a transaction in a payment processing system includes at least one processor and a non-transitory computer-readable medium containing instructions that, when executed by the at least one processor, cause the at least one processor to perform operations including receiving a transaction, classifying the transaction, analyzing the transaction, selecting a treatment to be applied to the transaction, applying the selected treatment to the transaction, and outputting the transaction after the selected treatment was applied to the transaction. Classifying the transaction includes computing a probability score vector for the transaction that indicates a probability for each of one or more possible outcomes of the transaction. Analyzing the transaction includes computing one or more probability mass vectors for the transaction that indicate impact values and associated probabilities of one or more possible treatments to be applied to the transaction. Selecting the treatment to be applied includes applying a set of decision rules to the probability score vector and the one or more probability mass vectors.

A transaction analysis unit for analyzing a transaction in a payment processing system includes at least one processor and a non-transitory computer-readable medium containing instructions that, when executed by the at least one processor, cause the at least one processor to perform operations including receiving a transaction, classifying the transaction, analyzing the transaction, selecting a treatment to be applied to the transaction, applying the selected treatment to the transaction, and outputting the transaction after the selected treatment was applied to the transaction. Classifying the transaction includes computing a probability score vector for the transaction that indicates a probability for each of one or more possible outcomes of the transaction. Analyzing the transaction includes computing one or more probability mass vectors for the transaction that indicate impact values and associated probabilities of one or more possible treatments to be applied to the transaction. Selecting the treatment to be applied includes applying a set of decision rules to the probability score vector and the one or more probability mass vectors.

### BRIEF DESCRIPTION OF DRAWINGS

FIG. 1 is a flow diagram of a system in which the present disclosure may be implemented, consistent with the disclosed embodiments.

FIG. 2 is a flow diagram of a system for analyzing financial transactions for treatment application, consistent with the disclosed embodiments.

FIG. 3 is a flow diagram of an example decision logic used by a treatment decision unit, consistent with the disclosed embodiments.

FIG. 4 is a flowchart of a method for analyzing financial transactions for treatment application, consistent with the disclosed embodiments.

FIG. 5 is a flowchart of a method for classifying a transaction, consistent with the disclosed embodiments.

FIG. 6 is a flowchart of a method for determining a treatment to apply to a transaction, consistent with the disclosed embodiments.

### DETAILED DESCRIPTION

The disclosed embodiments include systems and methods for analyzing a transaction in a payment processing system. Before explaining certain embodiments of the disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as in the accompanying drawings, are for the purpose of description and should not be regarded as limiting.

As such, those skilled in the art will appreciate that the conception upon which this disclosure is based may readily be utilized as a basis for designing other structures, methods, and systems for carrying out the several purposes of the present disclosure.

Reference will now be made in detail to the present example embodiments of the disclosure, examples of which are illustrated in the accompanying drawings. Wherever possible, the same reference numbers will be used throughout the drawings to refer to the same or like parts.

A method for analyzing a transaction in a payment processing system may include receiving a transaction. The transaction may be a purchase made by a buyer from a merchant, or other type of financial transaction using an electronic payment card that requires approval prior to authorization. The transaction may be received in various ways and from internal or external sources (e.g., through a client-facing application programming interface or connected to an adjacent internal upstream processing system). The transaction may be a streaming unit of bundled data points relating to various aspects of the transaction, such as buyer identifier, merchant identifier, transaction identifier, transaction amount, transaction date, and other data points that may be necessary for processing the transaction to determine whether the transaction should be approved or denied.

The transaction may be classified by a processor (for example) by computing a probability score vector for the transaction that indicates a probability for each of one or more possible outcomes of the transaction. The probability score vector may include one score for each possible transaction outcome. For example, each score in the probability score vector may be a floating-point number between 0 and 1, and the sum of all scores in the probability score vector may equal 1.

The transaction may be analyzed by a processor (for example) by computing one or more probability mass vectors for the transaction that indicate impact values and associated probabilities of one or more possible treatments to be applied to the transaction. Each impact mass probability vector represents a computed, discrete probability distribution of impact values of one of the possible treatments. The impact value may be expressed in financial terms and may represent a possible loss or gain on the transaction for each of the one or more possible treatments. Each treatment's impact mass probability vector may capture a range of impact values and associated probabilities indicating computed uplift values of that treatment compared to applying no treatment to the transaction. The impact value may reflect the estimated effect of each treatment with respect to the various possible outcomes of the transaction. Similar to the probability score vector, each probability in the probability mass vectors may be a floating-point number between 0 and 1, and the sum of all probabilities in a probability mass vector may equal 1.

Selecting a treatment to be applied to the transaction may be based on the probability score vector and the one or more probability mass vectors. A decision logic may apply a series of decision rules (for example) to examine the probability score vector and the probability mass vectors to select the treatment to be applied to the transaction. The rules may include comparing the probability score vector and the probability mass vectors to various thresholds and select the treatment to be performed based on the thresholds. For example, the thresholds may include a first threshold relating to the probability score vector, a second threshold relating to the probability in the probability mass vectors, and a third threshold relating to the impact value in the probability mass vectors. In one embodiment, a processor (for example) may compute an expected value for the transaction for all possible treatments to the transaction and across all possible outcomes and may select the treatment that results in the highest expected value for the transaction as the treatment to be applied to the transaction. The impact of each possible treatment may be captured in a single expected value, which may be computed as the inner product of the impact values vector and the associated probabilities vector.

The transaction outcome is influenced by the selected treatment applied to the transaction, and results from interactions with other entities in the payment processing system. The transaction outcome may be recorded for training machine learning models to assist in making future predictions of transaction outcomes, in either or both of the classifying the transaction and analyzing the transaction.

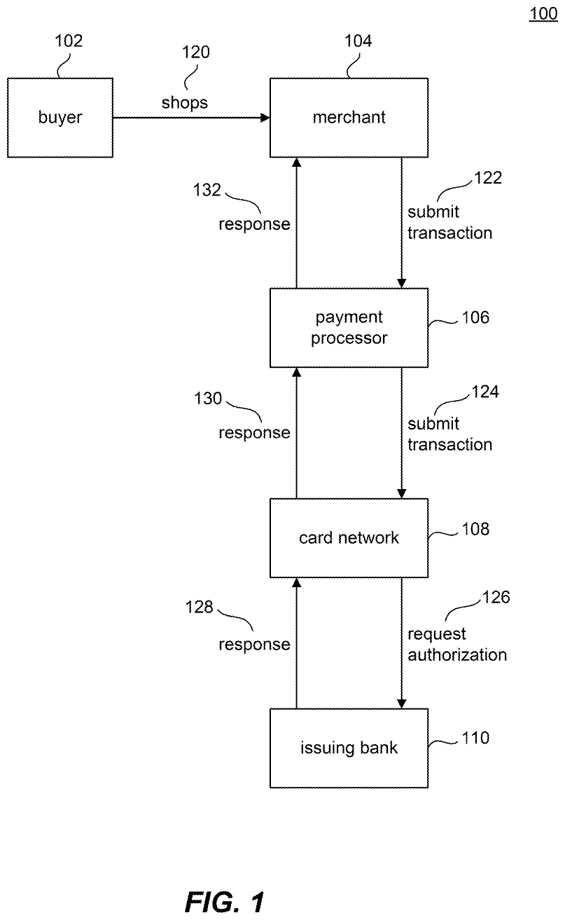

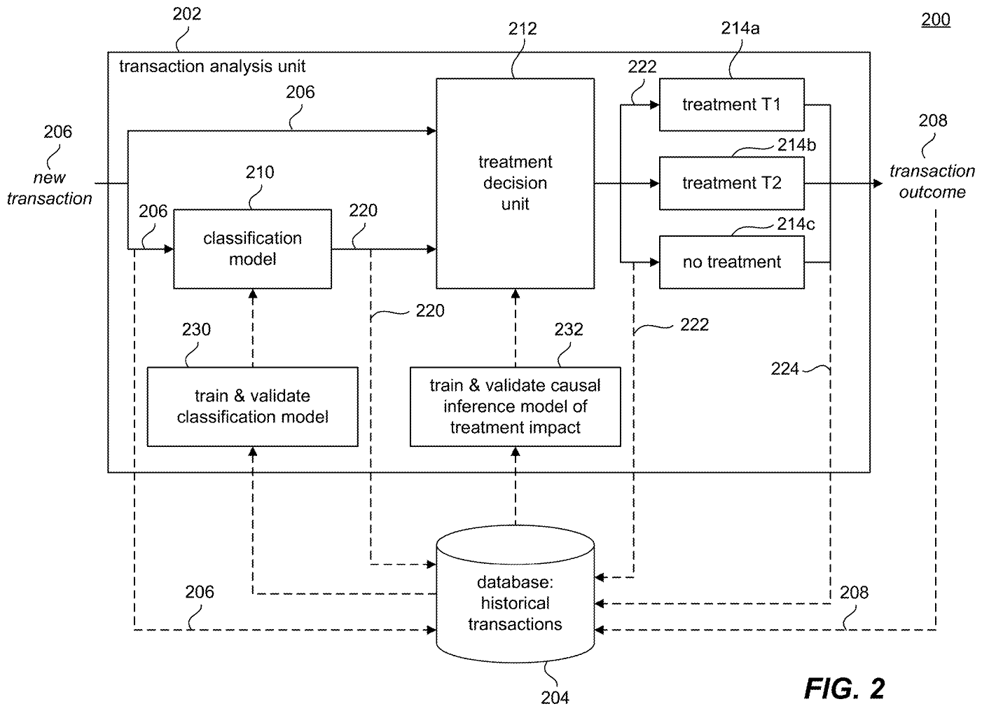

FIG. 2 is a flow diagram of a system 200 for analyzing financial transactions for treatment application. The system 200 may be implemented as a single unit in a payment processing system such as the payment processing system 100 shown in FIG. 1. In an embodiment, the system 200 may be implemented at more than one location, for example, in the payment processor 106, the card network 108, and/or the issuing bank 110.

The system 200 includes a transaction analysis unit 202 and a database 204 including stored historical transactions. The transaction analysis unit 202 may be implemented as software, hardware, or a combination of software and hardware. For example, the transaction analysis unit 202 may be implemented as software running on a processor. The processor may include a central processing unit (CPU), a graphics processing unit (GPU), an application-specific integrated circuit (ASIC), a field programmable gate array (FPGA), or other processing device configured to receive and process data and instructions.

The database 204 may be implemented in different formats such that the database 204 is capable of storing large volumes of semi-structured data (e.g., data in JavaScript Object Notation (JSON)). In an embodiment, the scalable storage provided by a cloud platform (e.g., Amazon Web Services, Google Cloud, or Microsoft Azure) may be sufficient to support the database 204. The transaction analysis unit 202 and the database 204 may be located in a single server or may be located in separate servers. The operation of the system 200 does not change based on the relative locations of the transaction analysis unit 202 and the database 204.

A new transaction 206 is analyzed by the transaction analysis unit 202 using machine learning models based on the stored historical transactions in the database 204 to predict a transaction outcome 208. The new transaction 206 can arrive at the transaction analysis unit 202 in various ways and from internal or external sources (e.g., through a client-facing application programming interface (API) or connected to an adjacent internal upstream processing system). For example, if the transaction analysis unit 202 is located at the card network (e.g., card network 108 as shown in FIG. 1), the new transaction 206 may arrive from the payment processor (e.g., payment processor 106 as shown in FIG. 1).

The new transaction 206 is a streaming unit of bundled data points arriving from one or more source(s). It is assumed the content and format of the new transaction 206 is consistent over time. This does not mean that every incoming new transaction 206 needs to have exactly the same data structure. For example, semi-structured data formats, such as the JSON data type, may contain extra branches depending on the origin of the new transaction 206. The interpretation of the data points in each transaction should not change rapidly over time. The use of hashing and tokens in the new transaction 206 is allowed, as long as the generating mechanisms behind the hashing or tokens do not change frequently, as this may hamper correct interpretation by the models.

In the transaction analysis unit 202, the new transaction 206 is sent to a classification model 210 and to a treatment decision unit 212. In an embodiment, the classification model 210 and the treatment decision unit 212 may be implemented as software, hardware, or a combination of software and hardware, either as separate units or as part of the transaction analysis unit 202. For example, the classification model 210 and the treatment decision unit 212 may be implemented as software running on a processor. The processor may include a CPU, a GPU, an ASIC, an FPGA, or other processing device configured to receive and process data and instructions.

The classification model 210 takes the new transaction 206 as input and produces a prediction 220 of probabilities of possible transaction outcomes. The classification prediction 220 is sent to the treatment decision unit 212. The treatment decision unit 212 uses a causal inference model 232, as discussed below, to determine whether to apply a treatment 214a, 214b, or 214c to the new transaction 206 (a treatment decision 222). After applying one or more treatments 214a-214c to the new transaction 206, it continues to be processed through the payment processing system (e.g., the payment processing system 100 as shown in FIG. 1) and ultimately reaches a transaction outcome 208. The treatments 214a-214c may include one or more possible treatments to the new transaction 206, including not applying any treatment to the new transaction (shown as treatment 214c).

The treatments 214a-214c are shown in FIG. 2 as two non-trivial treatment types (treatments 214a, 214b) plus a “no treatment” option (treatment 214c). There may be more or fewer than two treatment types and it is assumed there is always a “zero option” where no treatment is applied, but without loss of generality a “default treatment” may also be considered. In some embodiments, each treatment 214a-214c may represent a “soft interaction” with the new transaction 206, meaning that the treatment 214a-214c cannot block the new transaction 206 entirely (meaning that the new transaction 206 cannot be declined by the treatment decision 222). There are many potential manipulations of the new transaction 206 that may be considered a treatment: (i) data points in the transaction may be removed, edited, added, or shuffled; (ii) data security checks; (iii) customer security checks; (iv) dedicated AML (Anti-Money Laundering) checks; (v) KYC (Know Your Customer) checks; (vi) KYB (Know Your Business) checks; or (vii) credit risk checks. It is noted that this list of treatments is non-limiting and that other treatments are possible. The treatments may be executed internally or externally (e.g., through a client-facing application programming interface (API)). Implementations of the treatment(s) may include queries into internal or external databases, computations using any number of data points from the transaction as inputs, including computations by a statistical model, machine learning model, or artificial intelligence model (AI), and the additions of outputs of those computations back into the transaction as new data point(s). One treatment may consist of any number or combination of such manipulations.

In the context of a payment processing system (e.g., the payment processing system 100 shown in FIG. 1), specific examples of treatments and associated desired outcomes may include the following.

Strong Customer Authentication (SCA) checks, including asking for a password, mailing address, personal security questions, or a biometric check (e.g., a fingerprint or a self-portrait on a mobile device), are examples of “transaction treatments” since SCA is a soft intervention that may or may not be applied, and is aimed at influencing the transaction outcome 208. SCA is specifically aimed at preventing fraudulent outcomes in ecommerce payments.

Removal of data fields in the new transaction 206 with bad or missing content may be a treatment to decrease the number of declines by an issuing bank.

Applying tokenization to a sub-selection of data fields in the new transaction 206 may be used to increase acceptance rates by the card network. Different card networks may have different preferences, and it may not be the same type of tokenization that is preferred for all transaction segments, which means several treatments 214a-214c may need to be considered simultaneously.

The processing of the new transaction 206 to determine the predicted transaction outcome 208 is a primary synchronous prediction flow and is shown in FIG. 2 with solid lines. This part of the flow represents the relevant steps that the new transaction 206 goes through. This processing typically happens in “real-time” (i.e., practically instantaneously or without discernable delay; in most payment systems this may be a fraction of a second) for the sake of customer experience. It is noted that interactions with other payment processing infrastructure and other payment service providers have been left out of FIG. 2 for purposes of this discussion. The final step from treatment(s) to transaction outcome typically involves one or more interaction(s) with outside parties (such as an issuing bank or card network).

The transaction outcome 208 is observable, available, and quantifiable. Each new transaction 206 can only have one transaction outcome 208. Examples of transaction outcomes in the context of a payment processing system include: an authorized “genuine” sale, fraud (card networks distinguish various types of fraud), a chargeback (card networks distinguish various types of chargebacks), declined (the new transaction 206 is not accepted by the issuing bank and there exist various types), canceled, or refund. It is noted that the list of transaction outcomes is not exhaustive and that other transaction outcome types are possible.

In some embodiments, it may be assumed that there is one desired outcome that is favored over other possible outcomes. In this sense, a “favored outcome” may be determined by the entity that is operating the system 200. The system 200 may be operated by various entities in the payment processing system 100 and each entity may have different goals while operating the system 200. For example, a payment processor (e.g., payment processor 106) may be primarily concerned about maximizing its processing volumes and ease of payment for the buyer, but may also be concerned about compliance regarding fraud rates because of rules set by the card network (e.g., card network 108).

In some embodiments, getting to a “favored outcome” may take place implicitly as a result of how the entity that is operating the system 200 is using the transaction analysis unit 202 and how the entity chooses to configure the treatment decision unit 212 in connection with the chosen selection of treatments 214a-214c. The causal inference model training unit 232 may also be aware of what outcome is “favorable” by the way the model is set up. The distinction between how “favorable” an outcome is comes into play in the decision logic in the treatment decision unit 212. This may be reflected in the applied thresholds and the resulting decision to apply certain treatments 214a-214c, which may be encapsulated in the decision logic chosen by the entity operating the transaction analysis unit 202.

There may be a delay between the time the synchronous processing has finished and the observation of the definitive transaction outcome 208. For fraud and chargebacks in ecommerce payments, for example, it is not uncommon that fraud is reported up to 100 days after the transaction originally took place. Such delays, called “maturity,” may be considered when establishing the correct outcomes. In such circumstances, the delayed feedback may still be included in the database 204 and used in training the classification model 210 and the treatment decision unit 212.

The remaining actions and flows indicated by other arrow types are asynchronous and do not need to happen in real-time. The dashed lines in FIG. 2 indicate asynchronous flows of data points stored in the database 204. In some embodiments, the new transaction 206, the classification prediction 220, the treatment decision 222, the treatment result 224, and the transaction outcome 208 are all stored in the database 204.

The dashed lines in FIG. 2 from the database 204 to the classification model 210 and treatment decision unit 212 represent the performance evaluation and (re-)training of these two models (shown in FIG. 2 at boxes 230 and 232) based on past transactions and their outcomes. After (re-)training, the trained models are ready to make predictions on new transactions and will be installed in the synchronous flow environment, replacing the previous model version. The frequency at which retraining occurs depends on the nature of the data flow and possible changes over time: the throughput volumes, the proportion of observed outcome classes, and the number of available treatments all contribute to this.

The transaction outcome 208 becomes a “label” used as the target variable in the supervised training of the two models. To help train the models, the new transaction 206 is linked to its outcome label before committing to the database 204.

Transactions that are canceled by the buyer before the transaction is finalized, known as “drop-off,” are sometimes difficult to capture and store. It is important that all transactions after the treatment stage end up in the database 204 and are assigned a transaction outcome 208. Cancelations after the treatment stage may be assigned the outcome label “canceled,” while transactions that dropped off earlier in the process may be ignored. In some embodiments, to enable capturing the outcome of a transaction that may be canceled at a later point in time, a treatment result field may be added to the feedback sent to the database 204 (operation 224). As an example, the treatment result field may include a binary flag (e.g., a “yes/no” flag) that indicates whether a treatment was applied to the transaction. As another example, the treatment result field may include a detailed treatment result (e.g., “partial pass,” “full pass,” “high risk,” or other treatment result indication). In some embodiments, the training units 230 and 232 may treat any transaction that does not have an associated treatment result field as a canceled transaction. In these embodiments, the “canceled” label may be seen as an implicit outcome that follows from analysis of historical transactions that do not have a valid (or empty) treatment result field.

The classification model 210 quantifies the propensity of the new transaction 206 to reach a certain (discrete) outcome state. For example, in a payment processing system where two outcomes are possible (genuine sales and fraudulent attempts), a binary classification model may be used to predict the probability that a transaction turns out to be fraud. The output of the classification model may be seen as a risk score. As another example, if there are more than two possible transaction outcomes, a multi-class classification model may be used for the classification model 210.

In one embodiment, the classification model 210 receives the new transaction 206 as input, selects data fields from the new transaction 206, performs a transformation of the selected fields (including whatever parsing or pre-processing was defined during model training) to form a numerical feature vector, and computes a prediction in the form of a probability score vector. The data fields to be selected from the new transaction 206 are determined when the classification model 210 is initially trained. The probability score vector contains one score for each possible transaction outcome. In an embodiment, each score may be a floating-point number between 0 and 1, and the sum of all scores in a vector should equal 1. For example, if there are three different possible transaction outcomes O₁, O₂, O₃, then an example of a valid probability score vector (the classification model prediction 220) may be the vector P(O₁, O₂, O₃)=(0.35, 0.10, 0.55). It is noted that other embodiments of the probability score vector are possible and that the score for each possible transaction outcome may have different values; for example, each possible transaction outcome may be represented as an integer value between 0 and 100, and the sum of all scores in a vector should equal 100.

Fraud detection situations often require complex, so-called “stateful” feature vectors. This means that a number of entities (or “identifier variables”) are being tracked over time and become features of the input vector of the classifier. One example is the number of transactions with the same credit card in the past hour. In one embodiment, the classification model 210 and its related training and validation model 230 make use of stateful feature vectors.

In one embodiment, the classification model 210 may be a supervised statistical model with a discrete target variable and a multi-dimensional numerical input vector. Many machine learning (ML) and artificial intelligence (AI) models can be used as the classification model 210. One requirement of the classification model 210 is that the model can be deployed in a streaming system and produce predictions fast. For example, when the distinction between high risk and low risk outcome categories is known or is relatively straightforward to make, a Decision Tree algorithm may be a good algorithm choice. As another example, when there are many (e.g., more than ten) features that can be extracted from the transaction data, and their contributions to the propensity to reach a given transaction outcome is not easy to analyze from the context, more advanced classification learners such as Random Forest, Gradient Boosting, or Artificial Neural Networks may be used. As another example, a trivial classification model based on a single feature may be used which links outcome predictions directly to particular market segments, merchants, or industry sectors. It is noted that other ML or AI models may be used in the context of the present disclosure and that the choice of a particular ML or AI model as the classification model 210 does not alter the overall operation of the system 200.

The treatment decision unit 212 uses the causal inference model 232 to quantify the effectiveness of each available treatment 214a-214c with respect to reaching the most favorable outcome, which may be expressed as a transaction-level value in monetary terms. For purposes of explanation, the remainder of this discussion will base the monetary terms in U.S. dollars. It is noted that the transaction-level impact (or “uplift”) value of each outcome may be expressed in any currency or other monetary value without affecting the overall operation of the system 200.

The transaction-level impact value may be interpreted as a net “uplift” of choosing a treatment Tᵢ over letting the transaction pass without treatment (e.g., treatment 214c). In an embodiment, the uplift values may contain confidence bounds (e.g., uncertainty ranges) or a probability mass function of the uplift value is computed for each treatment Tᵢ. The output of the causal inference model 232, for each incoming transaction 206, is a matrix of net value predictions for each available treatment Tᵢ with assigned probabilities. For example, Uplift(T1)=[ (−$1.00, 0.25); ($0.00, 0.40); ($1.00, 0.35)]. As shown in this example, each probability score may be a floating-point number between 0 and 1, and the sum of all probability scores in the matrix should equal 1. The example indicates that the causal inference model 232 predicts a negative uplift of $1.00 with a probability of 0.25, a zero uplift with a probability of 0.40, and a positive uplift of $1.00 with a probability of 0.35.

Historical transactional data from the database 204 are used to train the causal inference model 232. In some embodiments, the causal inference model 232 may be retrained at regular intervals, and the retraining may be automatically implemented. In general, for successful training and retraining of causal inference models, observations should exist of all treatments and across all outcomes, and preferably covering various “transaction segments.” As used herein, “transaction segments” are defined as significant subsets in the feature space of pre-treatment variables correlating with the outcome variables. As an example, a simple segmentation may be based on which merchant the transaction belongs to. As another example, more advanced segmentations may use data-driven unsupervised methods to identify clusters of transactions with observed similar behavior.

For example, Blocked Randomized Trials may be used as the causal inference model 232. Dividing the transactions into segments or “blocks” and applying treatments at random within each segment may be a good way to quickly gain insight into what the best treatment option(s) are for each segment.

As another example of causal inference model 232, Linear Regression may be used with an indicator variable (0/1) to capture the applied treatment, and a continuous vector variable for all pre-treatment variables to consider suspected confounding factors. An advantage of using Linear Regression is that it is a straightforward approach but considering non-linearities is computationally hard with Linear Regression in higher dimensions.

As another example of causal inference model 232, Matched Pairs or Nearest Neighbors methods may be used. With this type of model, a transaction is compared to a similar past transaction. The idea with this type of model is that the more similar two incoming transactions are to each other, the more likely that their treatment outcomes are to be the same.

As another example of causal inference model 232, Regression Discontinuity Design (RDD) may be used. A more customized modeling approach, RDD is a regression (linear or otherwise) with a sharp transition at the decision point between applying the treatment and not applying the treatment. As used herein, the classification model prediction 220 may be used as a continuous independent variable (an “assignment variable”) and (an estimate of) the net outcome value in monetary terms at the transaction-level as a dependent variable. For n available treatments (n>1), n−1 separate RDD models would be trained. The benefit of using RDD as the causal inference model 232 is the fact that all confounding variables thought to have an impact on the final transaction outcome were already captured in the classification model 210. Moreover, the use of a score threshold in the decision to apply a treatment 214a-214c provides a natural, sharp transition between untreated and treated observations that is required in RDD.

The treatment decision unit 212 is configured to decide, for all new transactions 206, which treatment 214a-214c should be applied, if any. By combining predictions from the classification model 210 and the causal inference model 232, the treatment decision unit 212 acts as a higher-level decision lever aimed at controlling the transaction outcomes 208. The treatment decision unit 212 does this in two steps: (1) it runs the causal inference model 232 to predict the transaction-specific benefit (e.g., net uplift value) of applying each of the available treatments 214a, 214b over not applying any treatment (treatment 214c); (2) it combines this treatment prediction with the classification prediction 220 to reach a decision on what (if any) treatment to apply, based on a set of logical rules. There is no “human-in-the-loop” involved in the decision process made by the treatment decision unit 212 at runtime.

The decision logic used by the treatment decision unit 212 depends on the system application and user preferences. In an embodiment, the decision logic may be a fixed, finite set of rules that takes the inputs from the classification model 210 and the causal inference model 232 and produces a single, unambiguous, automated decision on which treatment 214a, 214b to apply (including the option of no treatment; treatment 214c). The decision logic may include any one or more of: comparing the classification score(s) to set threshold(s); comparing the treatment uplift value(s) to set threshold(s); computing the expected value of each treatment 214a-214c; comparing the uncertainty value band of each treatment uplift to set threshold(s); computing the expected value across all outcomes; selecting the treatment 214a-214c with the highest expected uplift value; or selecting a treatment 214a-214c at random, or with a certain fixed probability. It is noted that the decision logic may include fewer, more, or different rules and reach a similar outcome as described herein.

In an embodiment, these rules may be combined in a decision tree to come to an implementable decision function consisting of multiple “if/then” statements and fit to compute real-time decisions. The decision function in the treatment decision unit 212 controls the way the system 200 decides between the treatment types 214a-214c. The thresholds and logic in the decision function are determined (and revised with an appropriate frequency) in an offline analysis based on past performance of both the classification model 210 and the causal inference model 232, and user preferences around how many transactions receive which treatment(s). The “user” may be, for example, the payments acquirer hosting the transaction analysis unit 202 and/or the merchant who submitted the new transaction 206.

Considerations in setting up the decision rules may be related to how long the system 200 has been running, how much history has been built up in the database 204, and the observed prevalence of the various treatments and outcomes. For example, the decision tree may initially decide between a single treatment and no treatment for a binary outcome. In this example, the decision logic may be to always apply treatment T₁ if the classification score prediction for outcome O₁ exceeds 0.80 and apply treatment T₁ with a probability of 5% to all other transactions; and in all remaining situations apply treatment T₂. In this example, outcome O₁ may represent a high-risk transaction outcome that may be avoided with treatment T₁ while treatment T₂ may represent a less impactful, lower cost treatment. This example rule allows gathering of treatment data without letting a high-risk transaction pass through. At a later point in time, an additional rule may be added such as “only apply treatment T₁ if the expected value of the treatment uplift is greater than $0.10.” By setting up the decision logic this way, the system 200 is flexible with respect to how the model outputs are used and produces a transparent outcome.

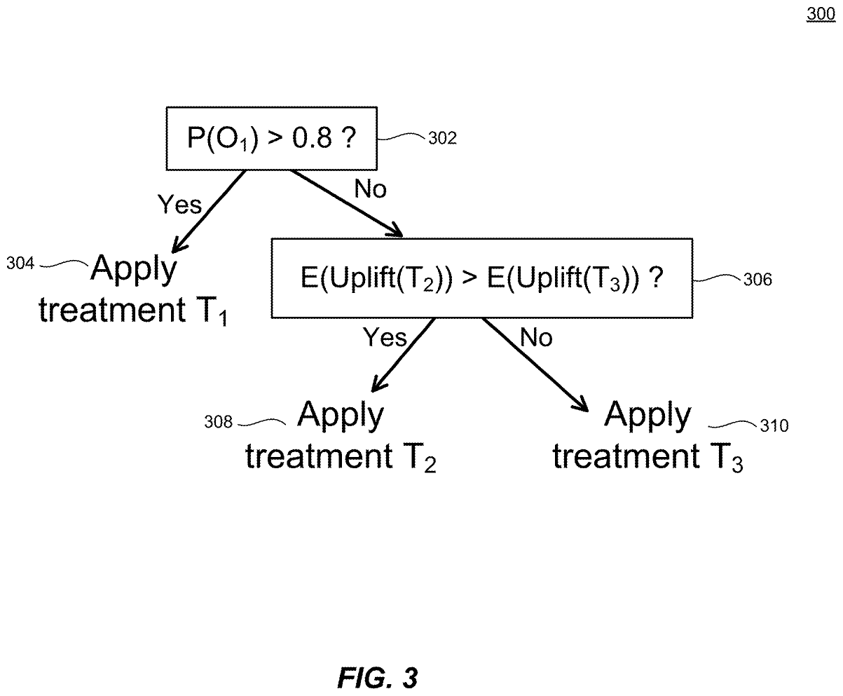

FIG. 3 is a flow diagram of an example decision logic 300 used by the treatment decision unit 212. In this example, there are two possible transaction outcomes (O₁ and O₂) and there are three available treatments (T₁, T₂, and T₃, where T₃ is a “no treatment” option). A decision tree may be used as the decision logic 300. P(O₁) denotes the predicted probability of outcome O₁ from the classification model 210. E(Uplift(T₂)) denotes the expected value of the computed uplift values and associated probabilities of treatment T₂ and E(Uplift(T₃)) denotes the expected value of the computed uplift values and associated probabilities of treatment T₃.

The decision logic 300 represents a series of steps leading to a choice of treatment to be applied. Once the decision logic 300 is set up (in some embodiments, in an offline design step), it is executed automatically by the treatment decision unit 212. A determination is made whether the classification model 210 predicts a probability of outcome O₁ greater than 0.8 (this is a “score threshold;” operation 302). It is noted that the score threshold of 0.8 is an exemplary value and that the score threshold may be set to any value by the entity operating the treatment decision unit 212. If the probability of outcome O₁ is greater than 0.8 (operation 302, “yes” branch) then treatment T₁ is applied (operation 304). If the predicted probability of outcome O₁ is less than 0.8 (operation 302, “no” branch), then a further check is performed based on the predicted treatment uplift values and related probability vector as produced by the causal inference model 232. In this example, the expected values for the uplift of treatments T₂ and T₃ are compared (operation 306). If the expected value for the uplift of treatment T₂ is greater than the expected value for the uplift of treatment T₃ (operation 306, “yes” branch), then treatment T₂ is applied (operation 308). If the expected value for the uplift of treatment T₂ is less than the expected value for the uplift of treatment T₃ (operation 306, “no” branch), then treatment T₃ is applied (operation 310). Thus, the treatment with the higher expected value for the uplift will be applied.

A more detailed example of the application of the decision logic 300 follows. A new transaction 206 arrives and the classification model 210 produces an outcome probability prediction vector P(O₁, O₂)=(0.3, 0.7). The causal inference model 232 running in the treatment decision unit 212 produces uplift predictions Uplift(T₁)=[(−$1.00, 0.4), (−$0.50, 0.6)], Uplift(T₂)=[($0.50, 0.35), ($0.75, 0.65)] and Uplift(T₃)=[($0.00, 1.0)] by default since T₃ represents “no treatment.” The decision logic 300 evaluates these values as follows. Because P(O₁)=0.3 (i.e., P(O₁)<0.8; operation 302), treatment T₁ is not applied. E(Uplift(T₂))=($0.50×0.35)+($0.75×0.65)=$0.66 and E(Uplift(T₃))=$0.00×1.0=$0.00, so E(Uplift(T₂))>E(Uplift(T₃)) (operation 306) and therefore treatment T₂ is applied to the new transaction 206 (operation 308).

Referring back to FIG. 2, in some embodiments, it may be beneficial to separate the classification model 210 from the causal inference model 232. A first benefit is that predicting the most likely outcome and treatment impacts separately enables the user to define finer-grained decision functions. The relevance of this is that within a segment of high-risk transactions, different treatments may be appropriate. There may exist high-risk transactions for which no effective treatments exist yet. Conversely, where treatments are potentially very effective for certain clusters of transactions, it may be the case that those transactions pose only low to moderate risk of turning into harmful outcomes such as fraud. All of this can be controlled in the treatment decision unit 212 because it receives and combines separate predictions for outcome probability and treatment impact. For example, a straightforward treatment decision logic in the treatment decision unit 212 would be to apply a treatment only if both the outcome risk score exceeds a certain threshold, and the treatment efficiency expressed in the uplift predictions is above a certain threshold level. Alternatively, it could be the user's preference to instead have a rule to always apply a treatment to outcome scores above a chosen threshold, regardless of estimated treatment impact.

A second benefit for having separate outcome and treatment impact scores is to be able to provide more transparency and explainability of the decision to apply treatments. In a case where unexpected outcomes are observed, the framework will be able to show why and how the treatment decisions were made.

A third benefit for having a separate classification model 210 and causal inference model 232 is that the proposed modeling configuration may be simpler to set up than an all-in-one model. For example, in an existing payment processing system that already has certain risk-scoring rules in place, it may be possible to add the causal inference model 232 and the treatment decision unit 212 while the existing risk rules act as the classification model 210.

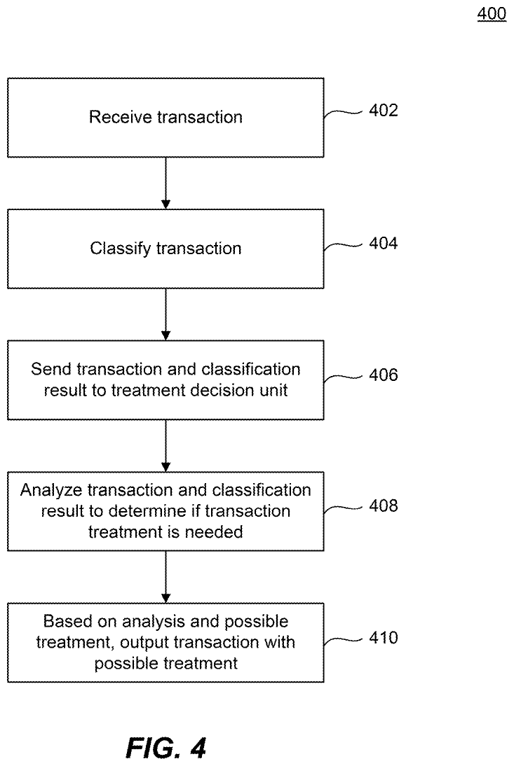

FIG. 4 is a flowchart of a method 400 for analyzing financial transactions for treatment application. In an embodiment and for purposes of discussion, the method 400 may be performed by the transaction analysis unit 202 shown in FIG. 2. A new transaction is received for processing by the transaction analysis unit 202 (operation 402). The new transaction may be received in various ways and from internal or external sources (e.g., through a client-facing application programming interface (API) or connected to an adjacent internal upstream processing system). For example, if the transaction analysis unit 202 is located at the card network (e.g., card network 108 as shown in FIG. 1), the new transaction may arrive from the payment processor (e.g., payment processor 106 as shown in FIG. 1).

The transaction is classified by the classification model 210 (operation 404). The classification model 210 takes the transaction as input and produces a prediction of possible transaction outcomes.

The new transaction and the classification model prediction are sent to the treatment decision unit 212 (operation 406). The treatment decision unit 212 analyzes the new transaction and the classification model prediction using a causal inference model to determine if a transaction treatment is needed (operation 408). As noted above, one or more of multiple possible transaction treatments may be applied to the new transaction, including the option of not applying any treatment to the new transaction.

The transaction receives treatment (or does not receive any treatment, depending on the decision in 408) and is then output back to the payment processing system (operation 410). This may be done in various ways and the output connection may internal or external (for example, through an application programming interface (API)). Depending on the type of treatment it has undergone, the output transaction may contain more or fewer data points, or modified data content, compared to when it was received (operation 402). Downstream interactions of the transaction with other entities in the payment processing system (such as checks performed by the issuing bank) result in a transaction outcome.

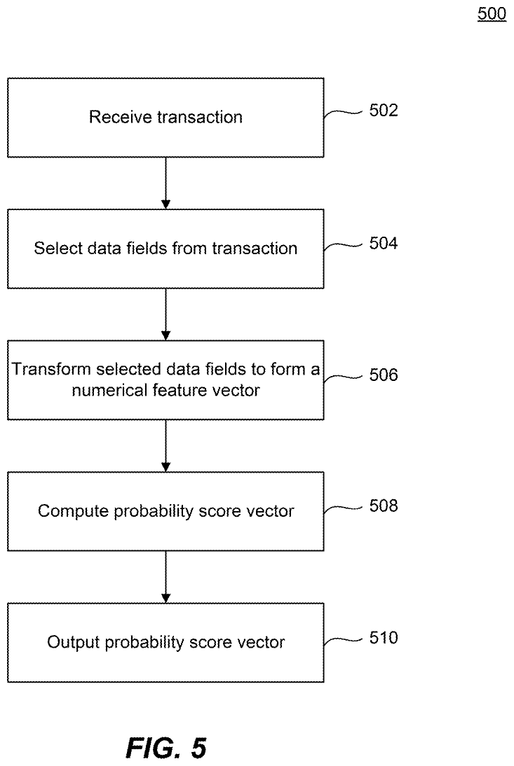

FIG. 5 is a flowchart of a method 500 for classifying a transaction, which may, in some embodiments, be a part of the method 400 of FIG. 4 (e.g., operation 404 of the method 400). In an embodiment, the method 500 may be performed by the classification model 210 shown in FIG. 2.

A new transaction is received by the classification model 210 (operation 502). The new transaction may be received in various ways and from internal or external sources (e.g., through a client-facing application programming interface (API) or connected to an adjacent internal upstream processing system). For example, if the transaction analysis unit 202 is located at the card network (e.g., card network 108 as shown in FIG. 1), the new transaction may arrive from the payment processor (e.g., payment processor 106 as shown in FIG. 1).

Data fields are selected from the new transaction (operation 504) and are transformed to form a numerical feature vector (operation 506). Because the data fields may vary between transactions (i.e., there may not always be a fixed format for all transactions), different data fields may be selected from different transaction types. Offline model preparations based on historical transaction samples define which data fields the classification model 210 selects. In the live system, the classification model 210 only selects appropriate fields and performs necessary parsing transformations or numerical transformations (operation 506).

Based on the numerical feature vector, the classification model 210 computes a probability score vector (operation 508). The probability score vector contains a score for each possible transaction outcome. In an embodiment, each score may be a floating-point number between 0 and 1, and the sum of all scores in a vector should equal 1. For example, if there are three different possible transaction outcomes (O₁, O₂, O₃), then an example of a valid probability score vector may be the vector P(O₁, O₂, O₃)=(0.35, 0.10, 0.55). It is noted that other embodiments of the probability score vector are possible and that the score for each possible transaction outcome may have different values; for example, each possible transaction outcome may be represented as an integer value between 0 and 100, and the sum of all scores in a vector should equal 100.

The probability score vector is output from the classification model 210 as the classification model prediction 220 (operation 510). The classification model prediction is sent to the treatment decision unit 212 for further processing and is stored in the database 204.

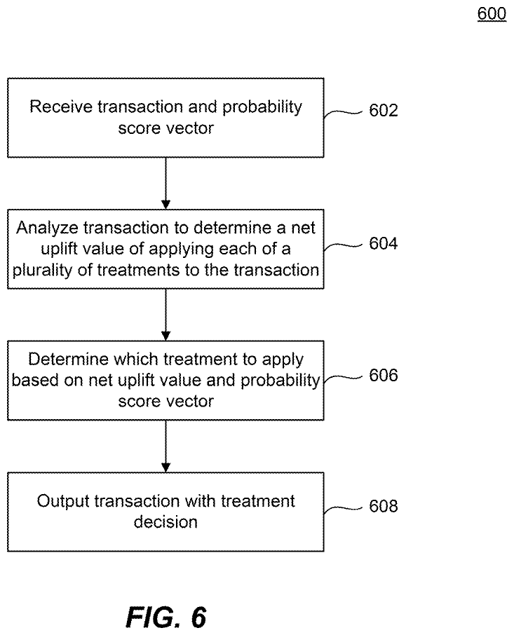

FIG. 6 is a flowchart of a method 600 for determining a treatment to apply to a transaction, which may, in some embodiments, be part of the method 400 of FIG. 4 (e.g., operation 410 of the method 400). In one embodiment, the method 600 may be performed by the treatment decision unit 212 shown in FIG. 2.

A new transaction and a probability score vector for the new transaction are received at the treatment decision unit 212 (operation 602). The new transaction may be received in various ways and from internal or external sources (e.g., through a client-facing application programming interface (API) or connected to an adjacent internal upstream processing system). For example, if the transaction analysis unit 202 is located at the card network (e.g., card network 108 as shown in FIG. 1), the new transaction may arrive from the payment processor (e.g., payment processor 106 as shown in FIG. 1). The probability score vector may be received from the classification model 210 (e.g., the classification model prediction 220).

The new transaction and the probability score vector are analyzed by the treatment decision unit 212 to determine a net uplift value of applying each of a plurality of treatments to the transaction (operation 604). This predicted transaction-specific value may be interpreted as a net “uplift” of choosing a treatment Tᵢ over letting the transaction pass without treatment. In an embodiment, the uplift values may contain confidence bounds (e.g., uncertainty ranges) or a probability mass function of the uplift value, which are computed for each treatment Tᵢ. The net uplift value predictions for each available treatment Tᵢ for each incoming transaction may be stored as a matrix with an assigned probability for each available treatment Tᵢ. For example, Uplift(T₁)=[(−$1.00, 0.25); ($0.00, 0.40); ($1.00, 0.35)]. As shown in this example, each probability score may be a floating-point number between 0 and 1, and the sum of all probability scores in the matrix should equal 1.

A treatment to be applied to the transaction is determined by the treatment decision unit 212 based on the net uplift value and the probability score vector (operation 606). The treatment decision unit 212 combines the treatment prediction with the classification model prediction to reach a decision on what (if any) treatment to apply, based on a set of logical rules. The logical rules may be a fixed, finite set of rules that takes the classification model prediction and the net uplift value predictions and produces a single, unambiguous, automated decision on which treatment to apply (including the option of no treatment). The treatment decision is applied to the transaction and output (operation 608), resulting in the transaction with treatment decision (222 in FIG. 2).

The treatment is applied to the transaction by treatments 214a-214c, resulting in the transaction with treatment result 224. This output transaction may or may not contain new data fields, altered data fields, or have data fields removed compared to the original transaction 206. The transaction then gets forwarded to adjacent internal systems of the same entity or to external entity systems. After the transaction has gone through all processing steps of the payment processing network, it reached its final state called the transaction outcome 208. The transaction outcome 208 becomes a “label” used as the target variable in the supervised training of the machine learning models (the classification model 210 and the causal inference model used by the treatment decision unit 212). To help train the models, the “new transaction” 206 is linked to its outcome label 208 before committing to the database 204.

A non-transitory computer-readable medium may be provided that stores instructions for a processor for analyzing a transaction in a payment processing system according to the example systems of FIGS. 1 and 2, and flowcharts of FIGS. 3-6 above, consistent with embodiments in the present disclosure. For example, the instructions stored in the non-transitory computer-readable medium may be executed by the processor for performing processes for analyzing a transaction in a payment processing system in part or in entirety. Common forms of non-transitory media include, for example, a floppy disk, a flexible disk, a hard disk, a solid-state drive, magnetic tape, or any other magnetic data storage medium, a Compact Disc Read-Only Memory (CD-ROM), any other optical data storage medium, any physical medium with patterns of holes, a Random Access Memory (RAM), a Programmable Read-Only Memory (PROM), an Erasable Programmable Read-Only Memory (EPROM), a FLASH-EPROM or any other flash memory, Non-Volatile Random Access Memory (NVRAM), a cache, a register, any other memory chip or cartridge, and networked versions of the same.

While the present disclosure has been shown and described with reference to particular embodiments, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, Python, R, Scala, Hypertext Markup Language (HTML), HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods, or portions of the steps of the disclosed methods, may be modified in any manner, including by reordering steps, inserting steps, repeating steps, and/or deleting steps (including between steps of different exemplary methods). It is intended, therefore, that the specification and examples be considered as illustrative only, with a true scope being indicated by the following claims and their full scope of equivalents.

What is claimed is:

1. A method for analyzing a transaction in a payment processing system, the method comprising:
receiving a transaction;
classifying the transaction, including computing a probability score vector for the transaction, wherein the probability score vector indicates a probability for each of one or more possible outcomes of the transaction;
analyzing the transaction, including computing one or more probability mass vectors for the transaction, wherein the one or more probability mass vectors indicate impact values and associated probabilities of one or more possible treatments to be applied to the transaction;
selecting a treatment to be applied to the transaction, including applying a set of decision rules to the probability score vector and the one or more probability mass vectors;
applying the selected treatment to the transaction; and
outputting the transaction after the selected treatment was applied to the transaction.

2. The method of claim 1, wherein the classifying includes:
selecting one or more data fields from the transaction;
transforming the selected one or more data fields to form a numerical feature vector; and
computing the probability score vector based on the numerical feature vector.

3. The method of claim 1, wherein the one or more possible outcomes of the transaction include: the transaction is authorized, the transaction indicates fraud, the transaction indicates a chargeback, the transaction is not authorized, the transaction is canceled, or the transaction is a refund.

4. The method of claim 1, wherein the impact value includes a monetary uplift of applying the selected treatment to the transaction.

5. The method of claim 1, wherein the one or more possible treatments to be applied to the transaction includes any one or more of: no treatment, adjusting a data field in the transaction, performing a data security check, performing a customer security check, performing an anti-money laundering check, or performing a credit risk check.

6. The method of claim 5, wherein adjusting a data field in the transaction includes any one or more of: removing a data field, editing a data field, adding a data field, or reordering the data fields in the transaction.

7. The method of claim 1, wherein the set of decision rules includes a set of logic rules.

8. The method of claim 1, further comprising:
feeding back the transaction outcome to a classification model, wherein the classifying the transaction applies the classification model to predict the probability of each of the one or more possible outcomes of the transaction.

9. The method of claim 1, further comprising:
feeding back the transaction outcome to a treatment impact training model, wherein the analyzing the transaction applies the treatment impact training model to predict the probability and the impact value of applying each of the one or more possible treatments to the transaction.

10. A system for analyzing a transaction in a payment processing system, the system comprising:
at least one processor; and
a non-transitory computer-readable medium containing instructions that, when executed by the at least one processor, cause the at least one processor to perform operations comprising:
receiving a transaction;
classifying the transaction, including computing a probability score vector for the transaction, wherein the probability score vector indicates a probability for each of one or more possible outcomes of the transaction;
analyzing the transaction, including computing one or more probability mass vectors for the transaction, wherein the one or more probability mass vectors indicate impact values and associated probabilities of one or more possible treatments to be applied to the transaction;
selecting a treatment to be applied to the transaction, including applying a set of decision rules to the probability score vector and the one or more probability mass vectors;
applying the selected treatment to the transaction; and
outputting the transaction after the selected treatment was applied to the transaction.

11. The system of claim 10, wherein the non-transitory computer-readable medium contains further instructions for the classifying that, when executed by the at least one processor, cause the at least one processor to:
select one or more data fields from the transaction;
transform the selected one or more data fields to form a numerical feature vector; and
compute the probability score vector based on the numerical feature vector.

12. The system of claim 10, wherein the one or more possible outcomes of the transaction include: the transaction is authorized, the transaction indicates fraud, the transaction indicates a chargeback, the transaction is not authorized, the transaction is canceled, or the transaction is a refund.

13. The system of claim 10, wherein the one or more possible treatments to be applied to the transaction includes any one or more of: no treatment, adjusting a data field in the transaction, performing a data security check, performing a customer security check, performing an anti-money laundering check, or performing a credit risk check.

14. The system of claim 13, wherein the non-transitory computer-readable medium contains further instructions for adjusting a data field in the transaction that, when executed by the at least one processor, cause the at least one processor to perform any one or more of: removing a data field, editing a data field, adding a data field, or reordering the data fields in the transaction.

15. The system of claim 10, wherein the non-transitory computer-readable medium contains further instructions that, when executed by the at least one processor, cause the at least one processor to:
feed back the transaction outcome to a classification model, wherein the classifying the transaction applies the classification model to predict the probability of each of the one or more possible outcomes of the transaction.

16. The system of claim 10, wherein the non-transitory computer-readable medium contains further instructions that, when executed by the at least one processor, cause the at least one processor to:
feed back the transaction outcome to a treatment impact training model, wherein the analyzing the transaction applies the treatment impact training model to predict a range of impact values and associated probabilities of applying each of the one or more possible treatments to the transaction.

17. A transaction analysis unit for analyzing a transaction in a payment processing system, the transaction analysis unit comprising:
at least one processor; and
a non-transitory computer-readable medium containing instructions that, when executed by the at least one processor, cause the at least one processor to perform operations comprising:
receiving a transaction;
classifying the transaction, including computing a probability score vector for the transaction, wherein the probability score vector indicates a probability for each of one or more possible outcomes of the transaction;
analyzing the transaction, including computing one or more probability mass vectors for the transaction, wherein the one or more probability mass vectors indicate impact values and associated probabilities of one or more possible treatments to be applied to the transaction;
selecting a treatment to be applied to the transaction, including applying a set of decision rules to the probability score vector and the one or more probability mass vectors;
applying the selected treatment to the transaction; and
outputting the transaction after the selected treatment was applied to the transaction.

18. The transaction analysis unit of claim 17, wherein the transaction analysis unit is located at any one or more of: a payment processor, a card network, or an issuing bank.

19. The transaction analysis unit of claim 17, wherein the non-transitory computer-readable medium contains further instructions that, when executed by the at least one processor, cause the at least one processor to:
feed back the transaction outcome to a classification model, wherein the classifying the transaction applies the classification model to predict the probability of each of the one or more possible outcomes of the transaction.

20. The transaction analysis unit of claim 17, wherein the non-transitory computer-readable medium contains further instructions that, when executed by the at least one processor, cause the at least one processor to:
feed back the transaction outcome to a treatment impact training model, wherein the analyzing the transaction applies the treatment impact training model to predict the probability and the impact value of applying each of the one or more possible treatments to the transaction.
